(19) United States
(12) Patent Application Publication
(10) Pub. No.: US 2006/0262451 A1
(43) Pub. Date: Nov. 23, 2006

(54) Hard-disk drive design for contact recording applications

(75) Inventors: Andrei Khurshudov, San Jose, CA (US); Michael Thomas Sullivan, Fremont, CA (US); George W. Tyndall, San Jose, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd.

(21) Appl. No.: 11/132,787

(22) Filed: May 18, 2005

(51) Int. Cl. G11B 5/012; G11B 17/00; G11B 33/14

(52) U.S. Cl. 360/97.01

(57) ABSTRACT

A hard disk drive that has a liquid bearing between a head and a disk of the disk drive. The drive includes a spindle motor and an actuator arm assembly coupled to a base plate. The disk and the head are coupled to the spindle motor and actuator arm assembly, respectively. The liquid bearing is formed between the head and the disk. By way of example, the liquid bearing can be formed by the condensation of a vapor within the disk drive assembly. The liquid bearing can minimize mechanical wear while optimizing signal strength in the signal detected by the head.

### BACKGROUND OF THE INVENTION

1. Field of the Invention

The present invention relates to a liquid bearing between a head and a disk of hard disk drive.

2. Background Information

Hard disk drives contain a plurality of magnetic heads that are coupled to rotating disks. The heads can magnetize and sense the magnetic fields of the disks to write and read data, respectively. The heads each have an air bearing surface that cooperates with a flow of air generated by the rotating disk to create an air bearing. The air bearing prevents mechanical wear between the head and the disk.

The strength of the magnetic flux and the corresponding electrical signal sensed by the head is inversely proportional to the height of the air bearing. The higher the air bearing, the lower the signal. It is generally desirable to minimize or even eliminate the gap between the head and the disk. Unfortunately, minimizing or eliminating the gap increases the mechanical wear between the head and the disk surface. Consequently, when designing an air bearing there is always a tension between increasing the signal strength and minimizing mechanical wear. It is therefore desirable to provide a bearing between the head and disk that optimizes signal strength while minimizing mechanical wear.

### BRIEF SUMMARY OF THE INVENTION

A hard disk drive that has a liquid bearing between a head and a disk of the disk drive. The drive includes a spindle motor and an actuator arm assembly coupled to a base plate. The disk and the head are coupled to the spindle motor and actuator arm assembly, respectively. The liquid bearing is formed between the head and the disk.

### BRIEF DESCRIPTION OF THE DRAWINGS

FIG. 1 is a top sectional view of a hard disk drive;

FIG. 2 is an illustration showing a liquid bearing between a head and a disk of the hard disk drive;

FIG. 3 is a schematic of an electrical circuit for the hard disk drive.

### DETAILED DESCRIPTION

Disclosed is a hard disk drive that has a liquid bearing between a head and a disk of the disk drive. The drive includes a spindle motor and an actuator arm assembly coupled to a base plate. The disk and the head are coupled to the spindle motor and actuator arm assembly, respectively. The liquid bearing is formed between the head and the disk. By way of example, the liquid bearing can be formed by the condensation of a vapor within the disk drive assembly. The liquid bearing can minimize mechanical wear while optimizing signal strength in the signal detected by the head.

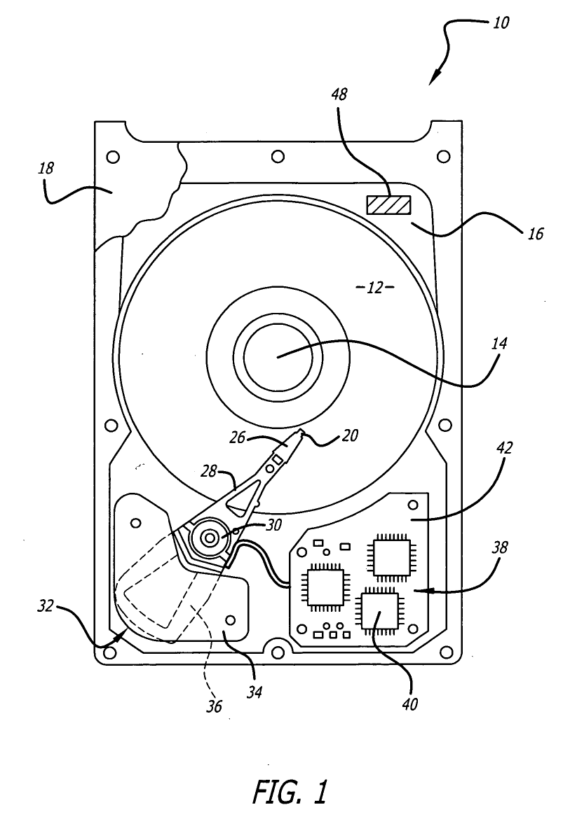

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write (not shown) and read elements (not shown). The heads 20 are gimbal mounted to a corresponding flexure arm 26. The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12. The actuator arm 28 and flexure arms 26 can collectively be referred to as an actuator arm assembly.

The hard disk drive 10 may include a printed circuit board assembly 38 that includes a plurality of integrated circuits 40 coupled to a printed circuit board 42. The printed circuit board 42 is coupled to the voice coil 32, heads 20 and spindle motor 14. The cover 18 and base plate 16 enclose the disk 12 and heads 20 of the disk drive 10.

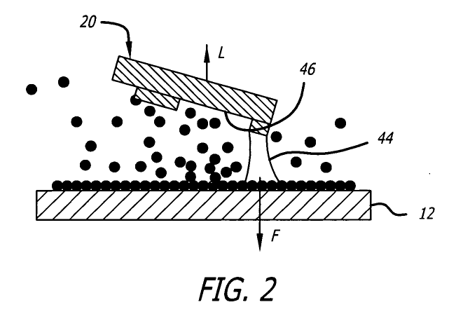

As shown in FIG. 2, a liquid bearing 44 is formed between the head 20 and the disk 12. The gap between the head 20 and the disk 12 is relatively small so that there is a capillary pressure in the liquid bearing 44. The capillary pressure produces an adhesive force that pulls the head 20 toward the disk 12 in accordance with the following equation:
F≈g·γ_{L}·cos θ (1)
Where;

F is the adhesive force;

g is a geometry dependent variable;

γ_{L} is the surface energy of the liquid;

θ is the contact angle of the liquid that is formed on the surfaces of the head and the disk.

From equation (1) it can be seen that the height and the stiffness of the liquid bearing (i.e. adhesive force F) can be varied by changing the type or composition of the liquid, γ_{L} the geometry of the head 20, and/or the chemical composition of the head and disk surfaces.

It may be desirable to create a negative load L on the head to somewhat offset the adhesive force F. The liquid bearing 44 will remain intact if the load L is less than the adhesive force F. The negative load L can be created by either the flexure (26 in FIG. 1) or the slider portion 46 of the head 20.

To control the formation of the liquid bearing 44, the head 20 can provide a DC voltage to strengthen the attraction between the head 20 and the disk 20. The negative load L may be greater than the adhesive load F but less than the combined effects of the DC voltage and the capillary pressure. When the DC voltage is not applied, the negative load L pulls the head 20 away from the disk 12 and breaks the liquid bearing 44.

The head 20 may include a heating element (not shown) that varies the temperature of the liquid. The adhesive force is inversely proportional to the temperature such that a rise in temperature will decrease the force F. The temperature may be raised to decrease the adhesive force to a level that is less than the load L, whereby the head 20 is pulled away from the disk 12 and the liquid bearing 44 is broken.

The liquid may be applied in bulk on the disk to create the liquid bearing. Unfortunately, the centrifugal force of the rotating disk will cause the liquid to become un-evenly distributed toward the outer diameter of the disk. As an alternate embodiment a vapor may be formed within the hard disk assembly. The vapor may be formed from a reservoir of liquid in the hard drive assembly that vaporizes under normal operating conditions.

Due to the high pressure between the head 20 and the disk 12 the vapor may condense between these two components to form the liquid bearing. This state of supersaturation occurs when the partial pressure of the vapor is greater than 1.

The following is an example of a vapor based system. One milligram of a hydrocarbon-based oil such as squalene may be applied to an activated carbon absorbent patch 48 (see FIG. 1). The normal operating temperatures and pressure within the hard disk drive cause the oil to vaporize. For this example, the partial pressure is approximately 0.2. The partial pressure being defined as P/P⁰ where P is the pressure of the vapor in the drive, and P⁰ is the saturation vapor pressure of the material. The head 20 has a slider surface that creates a pressure compression of approximately 10×. The compression causes the partial pressure in the bearing area to reach 2.0, wherein the vapor is supersaturated and condenses into a liquid bearing.

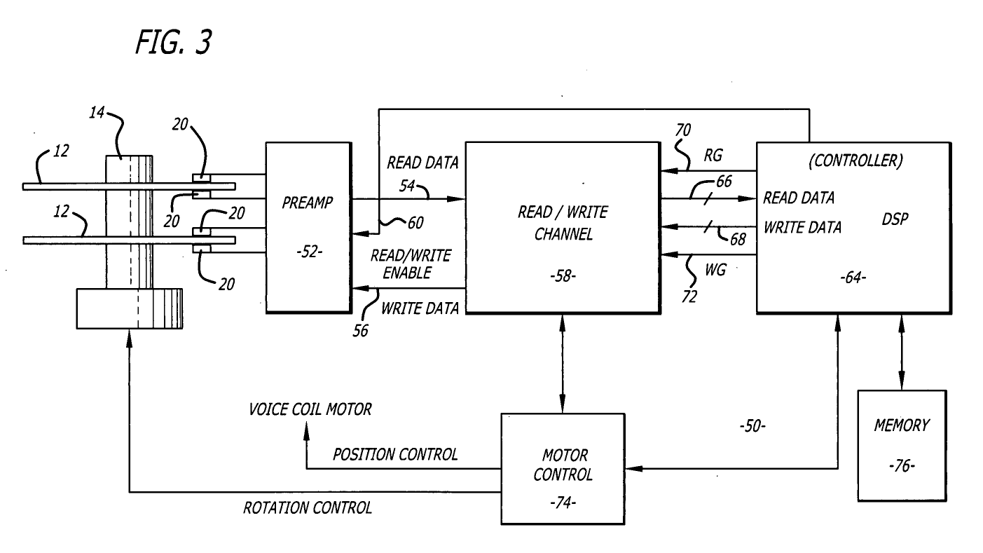

FIG. 3 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a firmware and/or software routine(s), including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”). The non-volatile memory 76 may contain the firmware and/or software routine(s) performed by the controller.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a base plate;
a spindle motor coupled to said base plate;
a disk coupled to said spindle motor;
an actuator arm assembly coupled to said base plate;
a head structurally coupled to said actuator arm assembly and magnetically coupled to said disk; and,
a liquid bearing located between said head and said disk.

2. The disk drive of claim 1, wherein said head has a negative load.

3. The disk drive of claim 2, wherein said liquid bearing creates an adhesive force that is opposite from and greater than the negative load.

4. The disk drive of claim 1, wherein said liquid bearing is formed from a lubricant.

5. The disk drive of claim 4, wherein said lubricant includes perfluoropolyether.

6. The disk drive of claim 1, wherein said liquid bearing is formed by a condensation of a vapor surrounding said head.

7. The disk drive of claim 6, wherein said vapor includes an oil.

8. The disk drive of claim 7, further comprising a lubricant that covers a surface of said disk.

9. The disk drive of claim 3, wherein said negative force is created by a flexure of said actuator arm assembly.

10. The disk drive of claim 3, wherein said negative force is created by said head.

11. A hard disk drive, comprising:
a base plate;
a spindle motor coupled to said base plate;
a disk coupled to said spindle motor;
an actuator arm assembly coupled to said base plate;
a head structurally coupled to said actuator arm assembly and magnetically coupled to said disk; and,
means for forming a liquid bearing between said head and said disk.

12. The disk drive of claim 11, wherein said head has a negative load.

13. The disk drive of claim 12, wherein said liquid bearing creates an adhesive force that is opposite from and greater than the negative load.

14. The disk drive of claim 11, wherein said liquid bearing is formed from a lubricant.

15. The disk drive of claim 14, wherein said lubricant includes perfluoropolyether.

16. The disk drive of claim 11, wherein said liquid bearing is formed by a condensation of a vapor surrounding said head.

17. The disk drive of claim 16, wherein said vapor includes an oil.

18. The disk drive of claim 17, further comprising a lubricant that covers a surface of said disk.

19. The disk drive of claim 13, wherein said negative force is created by a flexure of said actuator arm assembly.

20. The disk drive of claim 13, wherein said negative force is created by said head.

21. A method for operating a hard disk drive, comprising:
rotating a head relative to a disk; and,
forming a liquid bearing between the head and the disk.

22. The method of claim 21, wherein a negative force is applied to the head and the liquid bearing creates an adhesive force that is greater than the negative force.

23. The method of claim 21, wherein the liquid bearing is formed by the condensation of a vapor between the head and the disk.

24. The method of claim 21, further comprising applying a DC voltage between the head and the disk.

25. The method of claim 21, wherein a height of the liquid bearing is varied through application of thermal energy.
